(19) United States
(12) Patent Application Publication
(10) Pub. No.: US 2012/0216031 A1
(43) Pub. Date: Aug. 23, 2012

(54) METHOD FOR CONFIGURING THE GENERATION AND STORAGE OF OUTPUT DATA, COMPUTER SYSTEM, ELECTROMECHANICAL DEVICE, OPERATING SYSTEM AND DATA CARRIER

(76) Inventors: Thomas Baumgarth, Hohenkirchen-Siegertsbrunn (DE); Roland Eckl, Munchen (DE); Tobias Klitzke, Berlin (DE); Bernhard Kuhlicke, Berlin (DE); Asa Macwilliams, Furstenfeldbruck (DE); Norbert Paukner, Zwettl (AT); Christian Steinert, Pomaia (PI) (IT); Anton Wenzelhuemer, Wien (AT)

(21) Appl. No.: 13/504,403

(22) PCT Filed: Sep. 28, 2010
(86) PCT No.: PCT/EP10/64312

§ 371 Date: Apr. 26, 2012

(30) Foreign Application Priority Data
Oct. 27, 2009 (DE) 10 2009 050 795.7
Apr. 20, 2010 (DE) 10 2010 015 634.5

(51) Int. Cl. G06F 1/24

(52) U.S. Cl. 713/100

(57) ABSTRACT

A method for the configuration of the generation and storage of output data, e.g., logging outputs, in a computer system may include the following sequential steps: (a) operating a computer system in a first operating mode wherein first output data are created which are stored in a first output directory; (b) creating one or more specified second output directories; and (c) automatically shifting from the first operating mode to a second operating mode immediately after creating the second output directory, wherein different second output data are created in the second operating mode compared to the first output data. A computer system, an electromechanical device, an operating system, and/or a data carrier may also be provided for performing such method.

### CROSS-REFERENCE TO RELATED APPLICATIONS

This application is a U.S. National Stage Application of International Application No. PCT/EP2010/064312 filed Sep. 28, 2010, which designates the United States of America, and claims priority to DE Patent Application No. 10 2009 050 795.7 filed Oct. 27, 2009 and DE Patent Application No. 10 2010 015 634.5 filed Apr. 20 , 2010. The contents of which are hereby incorporated by reference in their entirety.

### TECHNICAL FIELD

The present disclosure relates to a method for configuring the generation and storage of output data. The present disclosure also to a computer system, a device, an operating system and a data medium for providing such method.

Aspects of the present disclosure, together with the problem area which underlies it, are explained below with reference to the generation and filing of logging output data, without however restricting the disclosure to this type of output data. In particular, aspects of the present disclosure can also be applied in general, in an appropriate way, to any arbitrary output data, such as for example general program outputs.

### BACKGROUND

In the case of a computer system, such as for example a personal computer (PC), so-called log files can be generated without the user of the PC being aware of this and without the user's work being influenced by it. Depending on the configuration, a log file contains an automatically maintained log of certain actions and processes on a computer system. This log file is also frequently referred to as an event log file or a system or program logbook, as applicable. Important applications are to be found mainly in process control and process automation. In principle, all the actions, events and results which may be required for later analysis can be recorded in these log files as they happen. In particular, action messages, fault/error messages, notes which are available permanently or for a short period, performance analysis data and the like can be filed in log files. These items of data are referred to as so-called logging output data, or logging outputs for short. Depending on the configuration, the generation and storage of these logging outputs in a log file can be undertaken or initiated by the operating system of the computer system, by appropriate programs running in the background, by web servers and the like.

Typically, the content of the log files and their storage location is known only to a limited circle of authorized personnel, such as the system administrator of the computer system, the program developer or individual authorized users. To the remaining users of the computer system, the content of these log files is generally not known, in particular because they have no interest in the content of the logging outputs stored there, and in general they do not even know how to begin with these logging outputs.

When configuring the logging, the system administrator will, for example, define the directory into which the logging outputs are to be written and the level of detail, if any, to which the logging outputs are to be filed. This configuration is, for example, set up so that the logging restricts the user as little as possible in the normal operating mode (so-called production operation). In production operation, the logging outputs collected are those which enable fault situations still to be understood at a later time. On the other hand, in the fault diagnosis mode, the system administrator is interested in the greatest possible amount of logging data, so that the fault can be diagnosed as precisely as possible. Here, an application-dependent compromise must be found between the requirements of the user of the computer system in the production mode and the needs in fault diagnosis mode. For this reason, a reconfiguration of the logging settings is usually necessary in the event of a fault. Typically, reconfiguring the logging settings is too complex for the user, especially as the latter does not know the place in the operating system at which to make the appropriate changes.

This reconfiguration of the logging settings can be very simply achieved if the system administrator is on-site. Frequently however, this is not the case.

With many computer systems, for example with very special application-specific computer systems and/or such as with very complex computer systems, a system administrator is generally not on-site, or in spite of the presence on-site of a system administrator the latter is not technically in a position to undertake this reconfiguration, because of the complexity of the computer system. It would, then, be possible for a system administrator to travel to the site specially for this on-site reconfiguration. However, this is impractical, and in addition is time- and cost-intensive. Many computer systems also deliberately do not provide for the possibility of a system administrator doing this configuring, in particular if the applications concerned are security-/safety-related. For the reasons cited, in the case of modern computer systems and in particular complex or security-/safety-related ones, this system administration is carried out online via the internet and/or via a hotline installed specifically for this purpose. This has proved to be an efficient and cost-effective approach.

However, a problem with this type of online- or hotline-based system administration is that the system administrator needs an on-site assistant in order to be able to undertake the appropriate actions which need to be carried out on-site. Also conceivable, but until now only possible to a limited extent or not at all, would be direct access by remote maintenance (such as via Remote Desktop). In the event of a fault, the user who is located on-site must however be able to find the log files in a simple way, in order to be able to make them accessible to the system administrator. The following methods exist for making it possible to find the log files:

Firstly, these log files can be arranged on the screen of the computer system at a position which is obvious to the user, for example on the Desktop in the case of a graphically enhanced operating system. These log files are then easy to find. However, they are distracting to the user in production operation, in particular if numerous other directories which the user requires are present on the Desktop.

Apart from this, the log files can also be filed in a central system directory for the computer system. A system administrator who is on-site could then access these log files in a simple manner. However, for the user these are generally difficult to find, because the user is typically not familiar with the system directory.

Over and above this, it would also be conceivable for the log files to be held in a special folder in the user directory, provided specifically for the purpose, and if necessary hidden. These files would then indeed not distract the user in everyday use, but in the event of a fault the user would also not be able to find these files in any simple way.

In summary, all three methods of making it possible to find the log files in the event of a fault have in common that the log files are either difficult to find or can distract the user in everyday use.

A further problem arises from the fact that the system administrator may, in the event of a fault, wish to undertake a reconfiguration of the logging, e.g., in order to obtain other logging outputs or perhaps also to obtain a larger volume of logging outputs. The user who is located on-site is, however, generally not technically in a position to undertake an appropriate reconfiguration of the logging.

### SUMMARY

In one embodiment, a method is provided for configuring the generation and storage of output data, e.g., logging outputs, in a computer system, with the successively executed steps: (a) operate a computer system in a first operating mode, in which are generated first output data items, which are filed in a first output directory; (b) create one or more predefined second output directories; and (c) automatically switch over from the first mode of operation into a second mode of operation immediately after the creation of the second output directory, whereby in the second mode of operation second output data items, which are different from the first output data items, are generated.

In a further embodiment, in the first operating mode, the first output data items are filed in a first output directory, and with the switch over into the second operating mode in step (c) the second output data items which are generated are filed in the second output directory.

In a further embodiment, following the switch over in step (c), then after a prescribed first period of time and/or due to deletion of the second output directory, the computer system is automatically switched back into the first operating mode again.

In a further embodiment, the second output directory is in the form of a log folder for filing logging data items, or of a music file for filing music data, in particular MP3 data.

In a further embodiment, the first and second operating modes identify a logging mode and the creation of the second output directory in step(b) effects a reconfiguration of the logging mode.

In a further embodiment, the second operating mode identifies a diagnostic mode, in particular a fault diagnosis mode.

In a further embodiment, more output data items, and in particular additional output data items, are determined in the second operating mode than in the first operating mode.

In a further embodiment, the second output directory is created at a location in the computer system which is immediately recognizable to the user and/or the second output directory is generated by the creation of a directory identified with a predefined name.

In a further embodiment, the computer system has a graphically enhanced operating system and the second output directory is created in step(b) in the Desktop folder of the operating system, or the computer system has a non-graphical operating system and the second output directory is created in step (b) is in the Home folder of the operating system.

In a further embodiment, at each startup of the operating system, or iteratively after a predefined second time period, the operating system of the computer system checks automatically, whether the second output directory exists.

In a further embodiment, the operating system of the computer system is arranged in such a way that several second directories can be created, these being associated with different configurations of the second operating mode.

In another embodiment, a computer system is provided, including an input device for creating directories, including a program controlled device which has an operating system, which incorporates a program for carrying out any of the methods discussed above, and including a storage device for filing output data generated by the program controlled device.

In another embodiment, a device, e.g., a medical-technical device, includes such a computer system for controlling the operation of the device.

In another embodiment, an operating system for a computer system is provided, which incorporates a program for carrying out any of the methods discussed above.

In another embodiment, a data medium is provided, e.g., a hard disk, DRAM, CD-ROM or USB stick, which stores a program for such an operating system.

### BRIEF DESCRIPTION OF THE DRAWINGS

Example embodiments will be explained in more detail below with reference to figures, in which:

FIG. 1 is a flow diagram to explain a first example embodiment;

FIG. 2 is a flow diagram to explain a second example embodiment;

FIGS. 3A-3C illustrate a graphical user interface of an example computer system to explain the sequence of events in a method according to an example embodiment; and

FIG. 4 is a block diagram of a computer system in accordance with an example embodiment.

### DETAILED DESCRIPTION

Some embodiments configure output data, e.g., logging output, generated for example by an operating system or program and/or make such output data more easily available.

Correspondingly, the following may be provided:
A method for configuring the generation and storage of output data, e.g., logging outputs, in a computer system, with the successive execution of the steps: (a) operate a computer system in a first operating mode, whereby first output data items are generated, and these are filed in a first output directory; (b) create one or more predefined second output directories; (c) automatically switch over from the first mode of operation into a second mode of operation immediately after the creation of the second output directory, whereby in the second mode of operation second output data items, which are different from the first output data items, are generated.
A computer system with an input device for the creation of directories, with a program-controlled device which has an operating system which incorporates a program for the execution of the methods disclosed herein, with a storage device for the filing of output data generated by the program-controlled device.
A device, e.g., a medical-technical device, which has a computer system for the purpose of controlling the operation of the device according to the methods disclosed herein.
An operating system for a computer system, which incorporates a program for the execution of the methods disclosed herein.
A data medium, e.g., a hard disk, DRAM, CD-ROM or USB stick, which stores a program for an operating system in accordance with the methods disclosed herein.

Some embodiments provide a method whereby the configuration for the generation and storage of output data is switched over in a very simple way, typically by one simple movement, from a first operating mode (e.g. production mode) to a second operating mode (e.g. fault diagnosis mode) (and vice versa), without the user having to know the details about the parameters of this configuration. In this way, the advantage is retained that in the first operating mode the output data does not distract the user because it is, so to speak, present in the background at a location which is difficult for the user to discover, if at all. By the creation of a special so-called second directory (that is, for example, in the event of a fault), these second items of output data (e.g. log output data) would come to the foreground, and thereby become visible for the user in a very simple way. The user can then read out, analyze or manipulate these items of information and output data in any required way, for example by making them available, by e-mail or internet, to a system administrator for analysis.

In some embodiments, computer system has at least two different configuration modes for logging; namely, on the one hand a form of logging provided for production operation, and a form of logging provided for fault diagnosis. Less logging data, or even none at all, would typically be required in production operation than in the fault diagnosis mode. For this reason, there will also preferably be less data or none at all written into the logging file in production operation than in the fault diagnosis mode. However, in the fault diagnosis mode these items of logging data must be more simply available to the user concerned. In some embodiments, in so-called production operation the user works in the usual way without, for example, the logging data which is constantly being generated in the background and written into the logging file distracting the user. In the fault diagnosis mode the user will, for example, create at a permanently defined place on the computer system's graphical user interface a special directory (namely the second output directory), doing which will have the effect that the operating mode then switches over to the fault diagnosis mode. This will take place automatically, simply due to the creation of the second output directory, with the effect that all the logging files will be diverted into the appropriate second output directory. This creation of the second output directory can also have the implication that other logging data, or a larger quantity of logging data, is generated.

By this means, the output data generated by an operating system can be configured as required, so that it is easily made more accessible when required.

Instead of diverting the output data into the second output directory, it would also be conceivable that this output data, or even only a part of it, is also written in addition into the first output directory which already exists, or into any other arbitrary directory which is prescribed by the operating system, so that to a certain extent a backup is available for this output data.

In one example embodiment, in the first operating mode the first output data items are filed in a first output directory. Immediately after, or preferably simultaneously with, the switch over into the second operating mode in step (c), the second output data items which are generated will be filed in the second output directory. The creation of the second output directory can thus be interpreted as a configuration command, whereby on the one hand a switch over from the first to the second operating mode is effected and whereby the output data which is subsequently generated is diverted into the second output directory.

In a example embodiment, following the switch over in step (c), then after a prescribed first period of time or a nominal or effective interval of time the second operating mode will automatically be abandoned again in order to return the computer system back to the first operating mode. In this case, provision could be made, for example, that the special output directory which was previously created is automatically deleted again.

In addition, or alternatively, the computer system can also be switched over by the deletion of the second output directory. For example, a computer system which is in the second operating mode would be put back into the first operating mode, for example, by the user simply deleting the specially-created second output directory. This would indicate to the computer system's operating system, or to the program, that the second operating mode is to be abandoned and the computer system should again be operated in the first operating mode. In addition, or alternatively, it would also be conceivable that an exit from the second operating mode is effected, for example, by a relocation of the second output directory or by the copying of the second output directory to another location.

In one example embodiment, the second output directory is in the form of a folder for the filing of logging data items. However, the method is also particularly advantageous if the second output directory is, for example, a directory for the filing of music data. If this folder is created, music data, for example MP3 files, will thereafter be written to this folder. It would also be conceivable for the second output directory to be in the form of a measured values folder for filing items of measured value data which are continuously being re-generated, or as a file for the filing of image data, in particular for digital images or video sequences, or suchlike.

In one example embodiment, each of the first and second operating modes identifies a logging mode. In this case, the creation of the second output directory in step (b) effects a reconfiguration of the logging mode.

In one example embodiment, the second operating mode identifies a diagnostic mode, in particular a fault diagnosis mode. In this case, the first operating mode can identify a normal mode or a logging mode, in which a logging output file is generated which, by comparison with the second operating mode, has a restricted volume.

In a particularly example embodiment, a larger volume of output data, and in particular additional output data, is provided in the second operating mode, for example a diagnostic mode or fault diagnosis mode, than in the first operating mode.

In a example embodiment, the second output directory is created at a location in the computer system which is immediately and easily recognizable to the user, for example at a place on a graphical user interface of the computer system which is obvious to the user. In the second operating mode, the items of output data written into this output directory are then immediately visible to the user, and are therefore also simple for the user to process, read out or manipulate in other ways.

In addition or alternatively, it would also be conceivable that the second output directory is generated by the creation of a directory identified with a predefined special name which is, for example, known only to the user or is named for them by the system administrator. If such a name is input when a new directory is being created, the operating system will recognize this directory as a second output directory and will immediately switch from the first operating mode into the second operating mode. As a result, the correspondingly generated second output data will be written into precisely this second output directory. In addition, or alternatively, provision could also be made that this second output directory with its special name is arranged at a location which the user can easily access or see.

In a example embodiment, the computer system has a graphically enhanced operating system (e.g. a Windows®-based operating system), where in this case the second output directory is created in step (b) is e.g. in the Desktop folder of the operating system. In the case that the computer system has a non-graphical operating system (e.g. a UNIX-based operating system), the second output directory created in step (b) is e.g. in the Home folder of the operating system.

In one example embodiment, at each restart of the operating system the computer system's operating system checks, preferably automatically, whether a second output directory exists. By this means, a check is made to determine whether it is the first or the second operating mode which is currently active. In addition or alternatively, it would also be conceivable that the computer system's operating system checks iteratively after a predefined second time period whether the second output directory already exists.

In one example embodiment, the computer system's operating system is arranged in such a way that several second directories can be created, these being associated with different configurations of the second operating mode. By this means, different configurations can be addressed, by different names for the second output directories. The diversification of these various configurations could, for example, be effected by differentiated identifications (e.g. different names) for the second output directory. In addition or alternatively, diversification of the configuration would also be possible in that for each of the different configurations different locations (e.g. storage locations, positions, graphical arrangements etc.) of the second output directory are provided. The different logging configurations could be distinguished from one another, for example, in that each of them is used to react to faults of differing seriousness. For example, faults in the determination of trace data are less serious than faults in the setting of the operating system or a program, and these are in turn less serious than so-called major system faults (fatal errors). For example, there are faults which have only a minor effect on the operating system and hence on the operation of the computer systems, and which thus lead only to a deterioration in the performance, the speed or the user-friendliness of this computer systems. On the other hand, major faults could lead to the computer system being no longer functionally competent for individual applications or for several of them, or in the extreme case being irreparably damaged by the fault. Using the classification of the various possible fault scenarios, and the diversified logging configuration which this implies, it is possible to take these circumstances into account.

The above embodiments and developments can, insofar as is meaningful, be combined with each other in any suitable manner. Further possible embodiments, developments and implementations include combinations, not explicitly cited, of features described herein with respect to various example embodiments.

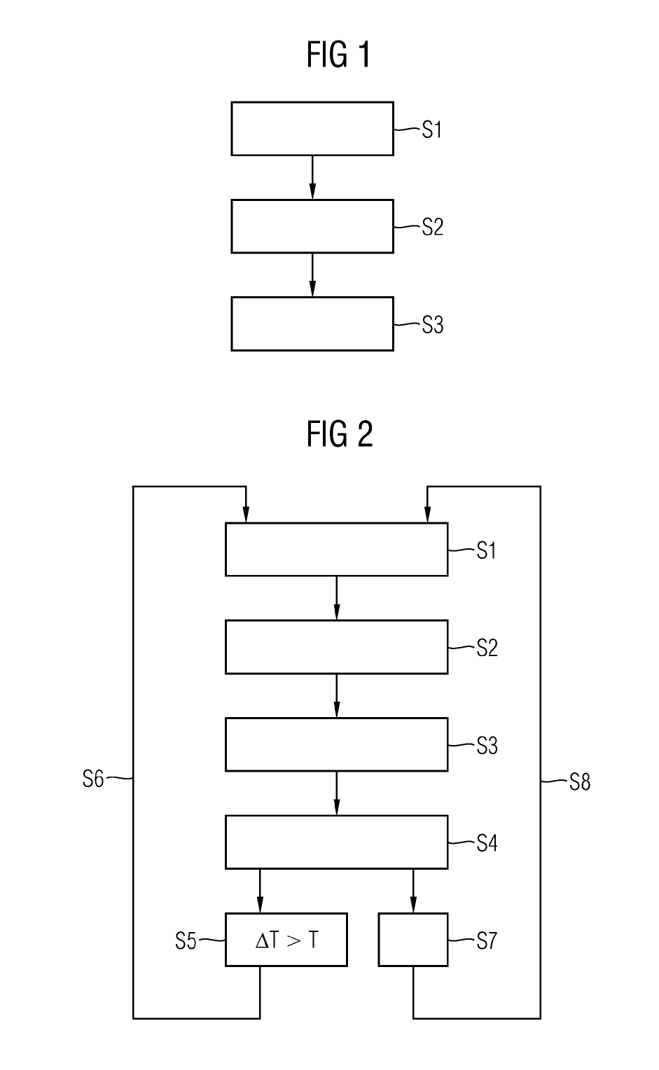

FIG. 1 is a flow diagram of a first method according to an example embodiment.

In step S1, the computer system is in a first operating mode.

The computer system in the present example is a computer system provided for a medical device. This first operating mode refers, for example, to a normal operating mode of the computer system. In this operating mode, first output data is continuously generated, for example first logging data. These items of logging data are continuously written into a first output directory. This first output directory could be, for example a directory which is located in the computer system at a place which is hidden from the user of the computer system, or is not immediately visible.

If a fault now arises in the computer system, or if the computer system is to be diagnosed, then the computer system must be reconfigured in respect of the logging. In accordance with certain embodiments, this is effected in step S2 by the creation of a second output directory. This second output directory again identifies, for example, a folder for log files and is provided for the purpose of accommodating second output data items, for example second logging data items. This second output directory is created by the user of the computer system. For the creation of this second output directory, the user will receive appropriate items of data, for example from the system administrator via a hotline set up specifically for the purpose, via the internet or e-mail, in order to be able to create this second output directory. These items of data relate, for example, to the name required for the creation of this second output directory. In addition or alternatively, the system administrator will give the user the name of a special position on the computer system's user interface, in the memory, in the operating system or the like, at which the second output directory should be created. It is important that this second output directory is created in a place which, from its name or its position, the user can very intuitively and very easily recognize and find again.

The creation of the second output directory by the user of the computer system indicates to the computer system's operating system that a reconfiguration of the logging is desired. Hence, in step S3, immediately after the creation of the second output directory, the operating system automatically switches over from the first operating mode into a second operating mode. In this second operating mode, second output data items are generated and, because of the reconfiguration, these are for example no longer written into the first output directory but are redirected. In addition, it would also be conceivable that other items of logging output data, in particular additional items, are generated by this new configuration. Because this second output directory is now arranged at a place which is very easy for the user to recognize and to find again, the user can make available to the system administrator, for example via e-mail or the internet, the items of second logging output data thus generated. It would also be conceivable that the system administrator reads out these second logging output data items directly and independently from the computer system e.g. over an internet link.

FIG. 2 is a flow diagram of a second method according to an example embodiment.

Unlike the example embodiment in FIG. 1, in the second example embodiment in FIG. 2 the second output data, generated in step S3, is immediately written into the second output directory (step S4).

In step S5, a measurement is made of the time period AT which has elapsed since the creation of the second output directory (step S2), or alternatively since the switch over into the second operating mode (step S3). If this measured time period AT exceeds a predefined time period T, which can for example be set via the operating system, then in step S6 the computer system is returned from the second operating mode back to the first operating mode. The computer system is then operated in the first operating mode (see step S1) until the user again creates the second output directory (step S2).

In FIG. 2, in an additional or alternative embodiment, in step S7 the second output directory is deleted again, relocated to another place on the user interface of the graphically enhanced operating system, or is renamed. The operating system can now be structured in such a way that this action by the user of the computer system is understood as a wish to reconfigure the logging. As a consequence of this, for example, a reconfiguration from the second operating mode back again to the first operating mode could be effected (step S8).

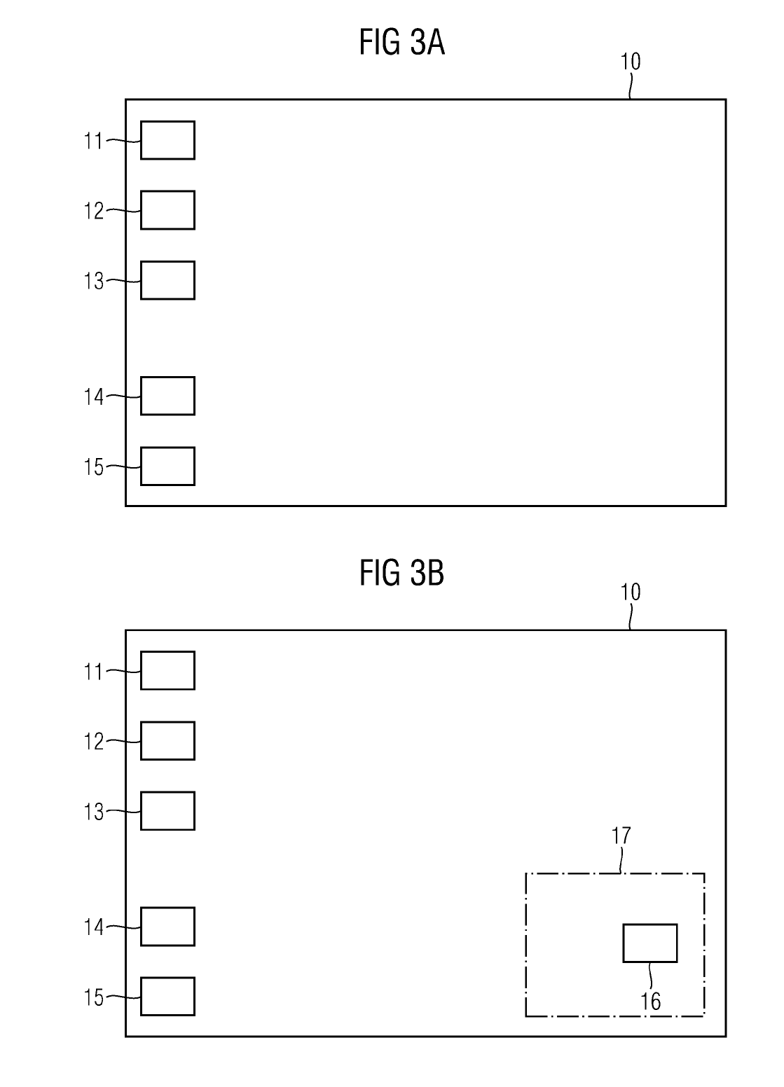

FIGS. 3A to 3C show a graphical user interface of a computer system for the purpose of explaining the sequence of activities. It is assumed that the operating system is a graphically enhanced operating system, such as for example a Windows operating system. The graphical user interface of this operating system is identified with the reference mark 10. In the case of a Windows operating system, this graphical user interface is the Desktop folder. On this interface 10 there are currently three directories 11, 12, 13 together with two programs 14, 15, each of which is identified by so-called icons.

In the example shown in FIG. 3A, the corresponding computer system is currently being operated in the first operating mode. It is true that in the first operating mode logging output data is also generated. However, this does not affect the graphical user interface 10 of the operating system (that is, the Desktop folder). So in the first operating mode, no directory is provided specially on the graphical user interface of the operating system for this logging output data. This first logging output data is then written at another location which, for example, is not known to, or is even completely inaccessible to, the user.

In the situation where a fault diagnosis is required, the user will create the second output directory 16 under instruction from the system administrator (see FIG. 3B). For this purpose the user will receive from the system administrator, for example, a specific name for this second output directory. The user will create on the computer system's graphical user interface 10 (the Desktop) a new directory 16 with precisely this specific name. Filed in the computer system's operating system is now the fact that when a new directory is created with precisely this specific name, the user and hence also the system administrator want a reconfiguration of the logging. Thereafter, all the new logging output data will be stored in this newly generated second output directory 16, that is in the new log folder 16. By simply clicking on this log folder 16, and thus opening it, the user can inspect and read out the content of this newly created log folder 16. FIG. 3C shows an example, identified by the reference mark 18, of the content of this newly created log folder 16, which appears when the log folder 16 is clicked on.

It is also conceivable that the second output directory 16 is not created by a specific predefined name but that it is created at a specific location 17 on the graphical user interface 10. In the example in FIG. 3B, this specific location 17 is provided at the bottom right on the graphical user interface 10. If this directory 16 is created at this location, then the operating system can, for example, interpret this as being the new second output directory 16 and hence that a reconfiguration of the logging is desired.

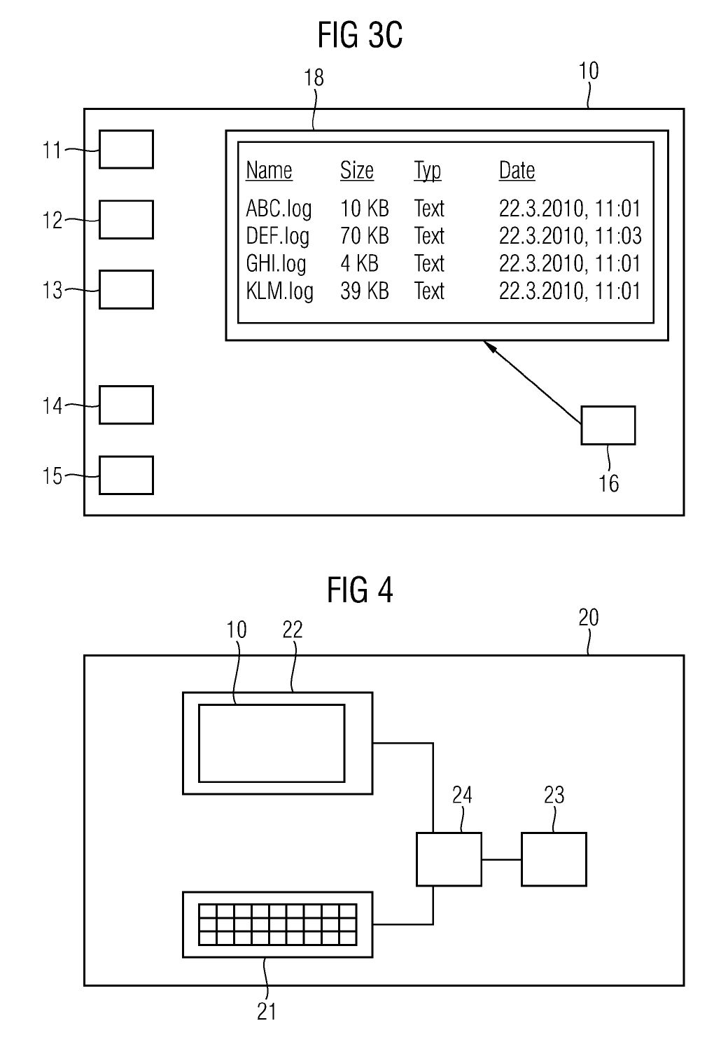

FIG. 4 shows a block diagram of a computer system in accordance with an example embodiment. The computer system is here identified by the reference mark 20. The computer system 20 has an input device 21, for example a keyboard, a mouse, a joystick or suchlike, a display device 22, for example a monitor, a display or suchlike, a storage device 23, for example a hard disk, a CD-ROM drive, a DRAM, a USB stick or suchlike, together with a program controlled device 24. The program controlled device can, for example, be a microprocessor, microcomputer, programmable logic circuits (e.g. FPGA, PLD, etc.). In the present example, the operating system of the computer system 20 is implemented in the program controlled device 24. A user can indicate a reconfiguration by using the input device 21 to create the new output directory 16. The operating system 24 accepts this input and reconfigures the logging appropriately.

In the present disclosure, embodiments have been described in such a way that the operating system creates the folder for the log data, makes the log data available and switches the method of operating between the modes. However, the disclosure should not be restricted to these embodiments. Instead, these tasks can also be performed by a program or for instance via the internet, so that in this context the term “operating system” should always be read to include “program”.

What is claimed is:

1. A method for configuring the generation and storage of output data, in a computer system, including the following successively executed steps:
(a) operate a computer system in a first operating mode, in which are generated first output data items, which are filed in a first output directory;
(b) create one or more predefined second output directories; and
(c) automatically switch over from the first mode of operation into a second mode of operation immediately after the creation of the second output directory, whereby in the second mode of operation second output data items, which are different from the first output data items, are generated.

2. The method of claim 1, wherein in the first operating mode, the first output data items are filed in a first output directory, and with the switch over into the second operating mode in step (c) the second output data items which are generated are filed in the second output directory.

3. The method of claim 1, wherein following the switch over in step (c), the computer system is automatically switched back into the first operating mode again in response to at least one of (a) passage of a prescribed first period of time and (b) deletion of the second output directory.

4. The method of claim 1, wherein the second output directory is in the form of a log folder for filing logging data items, or of a music file for filing music data, in particular MP3 data.

5. The method of claim 1, wherein the first and second operating modes identify a logging mode and the creation of the second output directory in step (b) effects a reconfiguration of the logging mode.

6. The method of claim 1, the second operating mode identifies a fault diagnosis mode.

7. The method of claim 6, wherein additional output data items are determined in the second operating mode than in the first operating mode.

8. The method of claim 1, wherein the second output directory is created at a location in the computer system which is immediately recognizable to the user.

9. The method of claim 1, wherein the computer system has a graphically enhanced operating system and the second output directory is created in step (b) in the a desktop folder of the operating system, or the computer system has a non-graphical operating system and the second output directory is created in step (b) is in a home folder of the operating system.

10. The method of claim 1, wherein at each startup of the operating system, or iteratively after a predefined second time period, the operating system of the computer system checks automatically, whether the second output directory exists.

11. The method of claim 1, wherein the operating system of the computer system is arranged in such a way that several second directories can be created, these being associated with different configurations of the second operating mode.

12. A computer system, with including an input device for creating directories, including a program controlled device having an operating system that incorporates a program, and a storage device for filing out-put data generated by the program controlled device,
wherein the program is configured to successively execute the following steps:
(a) operate a computer system in a first operating mode, in which are generated first output data items, which are filed in a first output directory;
(b) create one or more predefined second output directories; and
(c) automatically switch over from the first mode of operation into a second mode of operation immediately after the creation of the second output directory, whereby in the second mode of operation second output data items, which are different from the first output data items, are generated.

13-14. (canceled)

15. A program for an operating system, the program stored in a non-transitory data medium and executable by a processor to perform a method including
the following successive steps:
(a) operate a computer system in a first operating mode, in which are generated first output data items, which are filed in a first output directory;
(b) create one or more predefined second output directories; and
(c) automatically switch over from the first mode of operation into a second mode of operation immediately after the creation of the second output directory, whereby in the second mode of operation second output data items, which are different from the first output data items, are generated.
